(19) United States
(12) Patent Application Publication
(10) Pub. No.: US 2019/0122512 A1
(43) Pub. Date: Apr. 25, 2019

(54) SYSTEM FOR MONITORING ACCESS TO A VEHICLE

(71) Applicant: Airbus Operations GmbH, Hamburg (DE)

(72) Inventors: Marc Wesseloh, Hamburg (DE); Gerd Stahl, Hamburg (DE); Frank Möller, Hamburg (DE)

(21) Appl. No.: 16/156,243

(22) Filed: Oct. 10, 2018

(30) Foreign Application Priority Data
Oct. 20, 2017 (DE) 102017124583.9

(51) Int. Cl. G08B 13/196; G08B 13/24

(52) U.S. Cl. CPC G08B 13/1965; G08B 13/2494; G08B 13/19697; G08B 13/19652

(57) ABSTRACT

A system for monitoring access to a vehicle has a control unit, a plurality of sensor devices configured to be fastened to an outer side of the vehicle, are coupled to the control unit and are configured to capture objects in a three-dimensional manner in a field of view of the sensor devices, and at least one signal output device coupled to the control unit. The sensor devices are configured to capture objects in spatial areas predetermined by the relevant sensor devices and to transmit capture data representing the capture of objects to the control unit. The control unit is configured to receive and use the capture data to detect an object approaching a predefined monitoring area covered by the predetermined spatial areas of the sensor devices. The control unit is configured to transmit a control signal to the signal output device if an object is detected.

### CROSS-REFERENCES TO RELATED APPLICATIONS

This application claims the benefit of the German patent application No. 10 2017 124 583.9 filed on Oct. 20, 2017, the entire disclosures of which are incorporated herein by way of reference.

### BACKGROUND OF THE INVENTION

The invention relates to a system for monitoring access to a vehicle, to an aircraft having such a system, to an associated method and to a use of a LIDAR sensor device on a vehicle for monitoring access to a vehicle.

Vehicles which are parked at a location after their operation are often subject to a certain risk of theft and vandalism. For prevention and as a deterrent, it is known practice to integrate an anti-theft alarm system, in particular in the case of relatively small vehicles, for instance motor vehicles. The structure of this anti-theft alarm system depends on the type of vehicle. Ultrasonic sensors which monitor the interior are often used in motor vehicles, for instance. In the case of larger vehicles, for example aircraft, the use of cameras is known, in which case staff-based monitoring is likewise widespread.

Staff-based monitoring and the use of cameras in larger vehicles can ensure error-free monitoring for unauthorized access only through considerable deployment of personnel.

WO 2008 110 683 A1 shows an aircraft having a system for automatically detecting unauthorized persons in the vicinity of the aircraft. Radio transmitters, by means of which persons are authorized with respect to the aircraft, are used for this purpose.

### SUMMARY OF THE INVENTION

An object of the invention is to propose a system for monitoring access to a vehicle, which system can be operated in a particularly reliable, robust and at least largely automatic manner

A system for monitoring access to a vehicle is proposed, the system having a control unit, a plurality of sensor devices which can be fastened to an outer side of the vehicle, are coupled to the control unit and are intended to capture objects in a three-dimensional manner in the field of view of the sensor devices, and at least one signal output device which is coupled to the control unit. The sensor devices are designed to capture objects in spatial areas predetermined by the relevant sensor devices and to transmit capture data representing the capture of objects to the control unit. The control unit is designed to receive the capture data and to use the capture data to detect an object approaching a predefined monitoring area covered by the predetermined spatial areas of the sensor devices. The control unit is designed to transmit a control signal to the at least one signal output device if an object is detected. The signal output device is designed to output a warning signal if the control signal is received.

The control unit should be understood as meaning an electronic device which is able to process the capture data received from the sensor devices. For this purpose, the control unit has a processor which can execute an algorithm in the form of a program or the like in order to detect an object on the basis of the capture data. For this purpose, the processor can also be provided with a main memory and a memory unit for providing the program. In order to receive capture data, the control unit has at least one interface which is used to effect a connection or coupling to the sensor devices. The control unit can be implemented either as an independent, separate control unit or can be implemented, as an additional program, by means of a control unit which is already present.

The sensor devices are designed to capture objects in a three-dimensional manner in their field of view. The field of view can be considered to be a spatial area which has a direct visual connection to a sensor device. The field of view can ideally be a sphere but at least can comprise a cone, the tip of which is on the sensor device. The capture data provided by the sensor device may both comprise sensor-specific raw data and be data which have already been processed and/or filtered for further use inside the sensor device. The capture data may consequently also contain information relating to the position, the size and the speed of a captured object.

The control unit is designed to use the received capture data to determine whether an object is situated in or enters a predefined monitoring area. For this purpose, the control unit can preferably have knowledge of the geometry of the vehicle to be monitored. The monitoring area can be defined as a space or a volume surrounding the vehicle. The capture data provided by the sensor devices therefore allow the control unit to detect whether there is an object in this space or volume.

The control unit can preferably monitor the monitoring area continuously or at least in a clocked manner. In addition to the pure knowledge that there is an object in the monitoring area, a speed of a moving object can also be determined by comparing a plurality of successive scanning operations.

The sensor devices can preferably not merely detect a movement or an optical flow, but rather can provide capture data representing a current state of a spatial area. The state can comprise, in particular, information relating to clearances between the relevant sensor device and an object in a particular spatial direction.

The sensor devices may be implemented, in particular, by means of LIDAR sensors. In such a sensor, laser pulses are sent in a plurality of spatial directions covering a spatial area and reflection signals reflected by objects in the beam path are received. The distance to a captured object can be determined from the time of flight between the emitted laser pulse and the received reflection signal. The direction of the point resulting in the reflection can be determined by means of the respective spatial direction of the relevant laser pulse. A predefined spatial volume can consequently be scanned by covering larger angular ranges, with the result that the size of objects can also be detected in addition to the location and the distance of discrete points.

Other sensor devices based on other principles would also be alternatively possible. Ultrasonic sensors could be used as sensor devices, but a greater number of ultrasonic sensors in comparison with LIDAR sensors would be required on account of the limited range. Short-range radar sensors would also be possible. These sensors could use electromagnetic radiation with wavelengths in the millimeter range and with a low transmission power of considerably less than 100 mW. For example, a transmission power in the range of one to a few milliwatts could suffice to monitor the environment of relatively large passenger aircraft. If commercially available sensors are used, the frequency could be, for instance, in a range of between approximately 70 and 85 GHz, for example between 76 and 77 GHz or between 77 GHz and 81 GHz. No effects on health are expected in combination with the low transmission power.

On the basis of the capture data from a plurality of sensor devices, the control unit can consequently receive a data stream covering the entire monitoring area. The monitoring area can depend on the type and size of the vehicle. If the vehicle is, for example, an aircraft, in particular a passenger aircraft, it may be useful to limit the monitoring area to a volume defined by a distance of several meters around the outer side of the vehicle, for example. For successful monitoring, it is consequently important to provide a sufficient number of sensor devices and to position them on the vehicle in a useful manner.

If the control unit can determine an object, which is moving into the monitoring area or is in the latter, by means of the measures mentioned above from the received capture data, a control signal is transmitted to the at least one signal output device. This initiates a specific desired function which can be adapted by the manufacturer or operator of the vehicle. The signal output device can generally output a desired warning signal after receiving the control signal. It goes without saying that a multiplicity of different warning signals can be output if a plurality of signal output devices are used.

The warning signal can serve a plurality of purposes. On the one hand, an acoustic and optical warning can be directly output on the outer side or on the inner side of the vehicle. On the other hand, warning signals can also be transmitted to other locations and devices in order to output a corresponding warning at a location remote from the vehicle. In the example of the passenger aircraft, such a warning signal can be transmitted, for instance, to a guard or security facility in order to output a warning there to guard or security personnel. The warning signal could consequently be not only of an optical and acoustic nature but could also comprise the wireless or wired transmission of a signal. It is conceivable for the signal output device to have a device for transmitting a signal via a mobile radio network. This makes it possible, for example, to transmit a warning signal to an aircraft operator in order to accordingly inform the aircraft operator there of a detected event and to initiate further actions.

Furthermore, in addition to the general information relating to an event which has occurred, a warning signal can also comprise video images from an on-board camera or camera system and can be transmitted as a warning signal. The control signal can consequently also be used to activate a camera or a camera system or to initiate transmission of a signal or data stream provided thereby as a warning signal.

Access to a vehicle can be monitored in a largely automatic or automated manner by using a plurality of sensor devices having the features mentioned. The system allows a particular capture quality through the use of sensor devices which can capture objects in a three-dimensional manner There is no need for any permanent monitoring of the vehicle by personnel in situ or via a video system since objects are captured in a more precise manner than using motion sensors or camera systems alone. The use of LIDAR sensors, in particular, makes it possible to make a very reliable statement on the size and the location of an object, with the result that false alarms can be largely excluded.

As mentioned above, it is advantageous if the sensor devices are LIDAR sensors. This makes it possible to capture objects in a very precise manner and the size of the detected objects can be determined in a better manner than with conventional methods and systems. In addition, it is possible to use such a sensor device during the day and at night.

In one particularly advantageous embodiment, the control unit is designed to subdivide the monitoring area into a first capture area and a second capture area, wherein the first capture area is surrounded by the second capture area, and wherein the control unit is designed to transmit a first control signal to the at least one signal output device if an object is detected in the first capture area and to transmit a second control signal to the at least one signal output device if an object is detected in the second capture area. The vehicle can consequently be monitored with two warning levels. An inner, first capture area is a volume area around the vehicle with a relatively short spatial extent from the outer side of the vehicle. The second capture area adjoins the first capture area and consequently extends further outwards from the outer side of the vehicle. The monitoring can therefore distinguish between two events: the occurrence in an outer, second capture area around the vehicle, which has a lower criticality than the occurrence in a critical first capture area which completely adjoins the vehicle. The corresponding first or second control signal from the control unit can contain a corresponding item of information in both cases and can result in the initiation of different functions, for instance.

The system can also have a camera device as one of the at least one signal output device, wherein the control unit is coupled to the camera device, and wherein the system is designed to initiate and/or provide an image recording from the camera device when sending the control signal to the camera device. The camera device may already be part of the vehicle and can improve the security. In addition, if personnel are warned or notified with the aid of provided camera images, it is possible to determine in a relatively easy manner whether a false alarm could be involved.

The control unit is designed to determine the size of an end face of a detected object that is directed to one of the sensor devices and to transmit a control signal to the signal output device only above a predefined minimum size. It is therefore possible to exclude a particular action being carried out if a relatively small animal or another object having a small size approaches the vehicle.

The control unit is preferably designed to record at least one parameter if an object is detected for a predefined period, which parameter is selected from a group of parameters having a detection time, a size of the detected object, a speed of the detected object, and a position or a position profile of the detected object. A series of data items can hereby be inspected for subsequent tracking of a detected event.

The control unit is preferably designed to log a monitoring period. In particular, one or more of the parameters mentioned above are intended to be recorded in the monitoring period. The log can be checked for any anomalies at the end of or during the monitoring period. In addition to the parameters mentioned above, system-internal parameters could also be recorded. These may comprise the system time, the start of the recording and/or the state of sensor devices.

It is also advantageous if the system also has a data connection device as one of the at least one signal output device, wherein the data connection device is designed to set up a data connection to a device outside the vehicle and to transmit a warning signal to the device outside the vehicle. This device outside the vehicle may likewise be in the form of a signal output device. A warning resulting in a desired action can consequently be output in a device further away from the vehicle, in particular in the case of larger vehicles, for example aircraft and passenger aircraft, in particular. This device may be a control station of an airport and/or a deployment site of a guard service.

The invention also relates to an aircraft which has a system having the features described above. The aircraft may be in the form of a passenger aircraft, in particular, and may have a length and/or wingspan exceeding 10 m. The aircraft may be an aircraft having an aircraft fuselage, wings and at least one tail unit. However, the aircraft may also be a rotorcraft, that is to say a helicopter, in particular. The system can carry out reliable, automatic or automated monitoring which contributes to reducing personnel requirements and ensuring a high degree of safety during monitoring.

The predetermined spatial areas of all sensor devices particularly advantageously together contain at least all access openings of the aircraft. It is likewise useful to also monitor engines. It is also useful to monitor the landing gear. Particularly critical locations of the aircraft are therefore monitored.

One of the sensor devices is preferably arranged on an underside of a tail cone. This position allows a very large spatial area to be monitored by a single sensor device. An angle of approximately 360° about a vertical, that is to say the z axis of a vehicle-fixed coordinate system, can be covered. The tail cone often forms the rearmost area of a tapering aircraft fuselage. A sensor device arranged thereon can result in a rear part of the aircraft being monitored in a largely unimpeded manner

More preferably, two sensor devices are arranged in the area of a front edge of wings close to a wing root. The two sensor devices can monitor a front part of the aircraft in a largely unimpeded manner, which part comprises, for instance, an angular range about a vertical which extends from the respective wing front edge to beyond the longitudinal axis of the aircraft. In the case of passenger aircraft in particular, a spatial area of an aircraft extending from the ground to above the aircraft, from the wing front edge to in front of the aircraft, can be monitored. For example, an angular range about the vertical of approximately 100° to 180° can be covered. An angular range of approximately 120° to 160° and particularly preferably of approximately 140° can be covered in a particularly advantageous manner

A sensor device may also be arranged on a vertical tail unit. This may comprise, in particular, an area of a front edge, a rear edge or a top side of the vertical tail unit. For example, a sensor device can be arranged at an upper end of a front edge of the vertical tail unit in order to monitor virtually the entire area above the aircraft there.

The aircraft may also have a camera system as a signal output device. As a result, monitoring can be supported and the reception of a warning signal can be better assessed by means of camera images, in particular if guard staff are remote from the aircraft. It goes without saying that the camera system may also have an infrared camera and/or a thermal imaging camera and can also be assisted by a lighting device with visible light or light in the infrared range.

It is also advantageous if a wireless data connection device is present as a signal output device. The warning signal can therefore also be wirelessly transmitted to devices positioned outside the aircraft, as already explained above.

Finally, the invention relates to the use of one or more LIDAR sensors for monitoring access to the aircraft.

### BRIEF DESCRIPTION OF THE DRAWINGS

Further features, advantages and possible applications of the present invention emerge from the following description of the exemplary embodiments and the figures. In this case, all features described and/or illustrated in the figures form the subject matter of the invention alone and in any desired combination even irrespective of their composition in the individual claims or their dependency references. Identical reference signs in the figures still represent identical or similar objects.

FIGS. 1 to 3 show side, top and front views of an aircraft having a system for monitoring access to the aircraft.

FIG. 4 shows a schematic block-based illustration of the system.

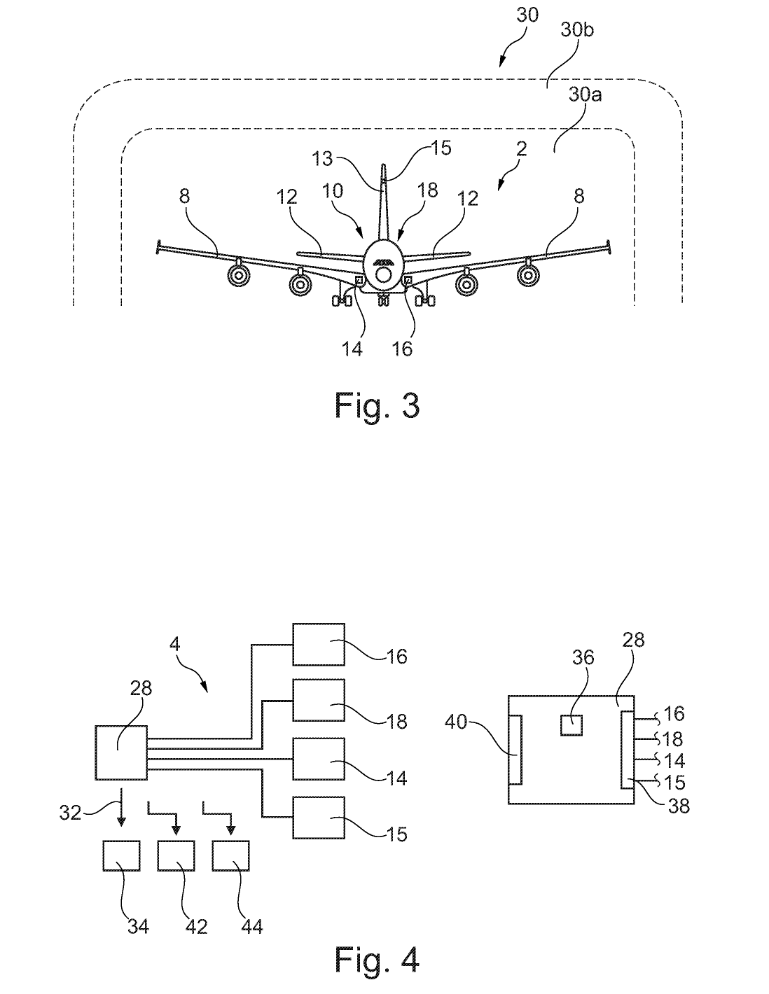

### DETAILED DESCRIPTION OF THE PREFERRED EMBODIMENTS

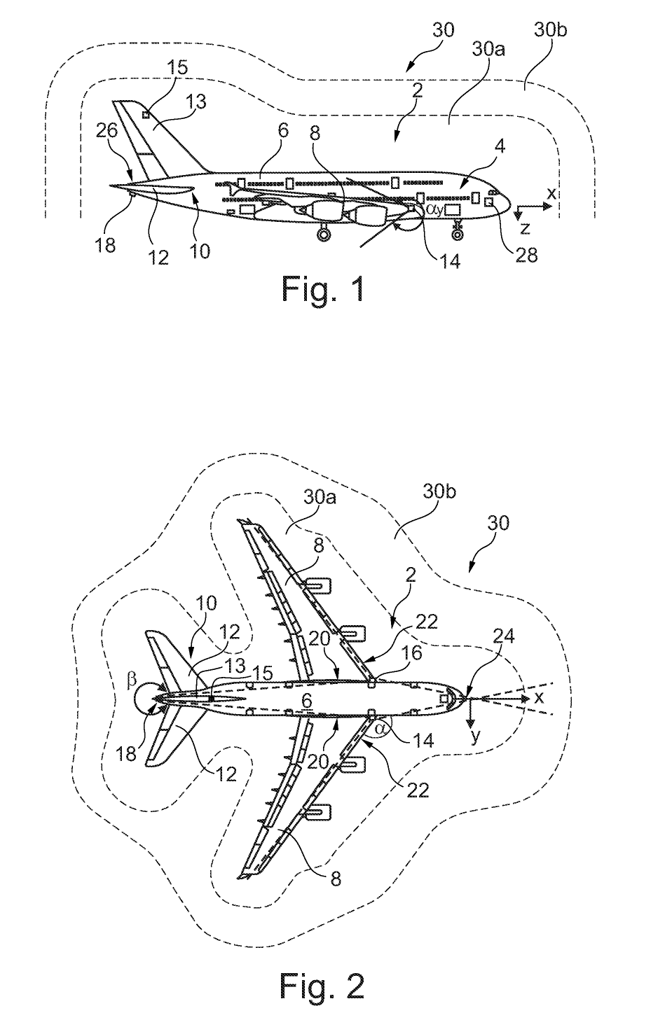

FIGS. 1 to 3 show three different illustrations of an aircraft 2 which is equipped with a system 4 for monitoring access to the aircraft 2. The aircraft 2 has an aircraft fuselage 6, two wings 8, a horizontal tail unit 10 comprising two tail unit halves 12 and a vertical tail unit 13. The outer surfaces of these components define the outer side of the aircraft 2.

The system 4 has, by way of example, four sensor devices 14, 15, 16 and 18 which are arranged at different positions on the outer side of the aircraft 2. It is noted in this case that not all sensor devices have to be used; in particular, the sensor device 15 is optional. Two front sensor devices 14 and 16 are used, by way of example, and are arranged on a front edge 22 of the wings 8 in the region of a wing root 20. The sensor devices 14, 15, 16 and 18 are preferably in the form of LIDAR sensors which can capture objects in a three-dimensional manner For this purpose, as explained above, laser pulses are sent in different spatial directions and reflection signals are received again. The distance to a captured object can be determined from the time of flight between the emitted laser pulse and the received reflection signal. A predefined spatial volume can be scanned by covering larger angular ranges, in particular, along two spatial axes. In addition to the distance of discrete points, the size of objects can also be detected as a cohesive group of discrete points by means of the scanning A speed of a moving object can also be determined by comparing a plurality of successive scanning operations.

An environment around the aircraft 2 can consequently be monitored by the sensors 14, 15, 16 and 18. The two front sensor devices 14 and 16 are designed, for example, to cover an angular range of approximately 140°, indicated by α, from their position. The viewing direction of the sensor devices 14 and 16 faces forwards, that is to say, extends from the front edge 22 to a fuselage nose 24. The angular range α preferably extends beyond a longitudinal axis x of the aircraft 2, with the result that the angular ranges α of the two sensor devices 14 and 16 overlap in front of the aircraft 2.

The sensor device 18 is arranged, for example, on an underside of a tail cone 26 and may have a considerably larger capture area of approximately 340°. This is indicated by β in FIG. 2.

The optional sensor device 15 arranged on the vertical tail unit 13 can be adapted, in terms of its capture area, to the other sensor devices 14, 16 and 18. However, a more or less large overlapping area of the individual capture areas may also be provided. For example, an angle of 180° or more can be achieved with the sensor device 15, depending on its installation position.

The sensor devices 14, 15, 16 and 18 consequently make it possible to detect an environment of the aircraft 2 in a substantially complete manner, in which case importance is placed, in particular, on monitoring close to the ground in the case of a large passenger aircraft. In addition to an angular range α about a vertical axis z of the aircraft 2, the sensor devices 14 and 16 may also cover an angular range αy about a transverse axis y of the aircraft 2. Depending on the installation position of the sensor devices 14 and 16, this angular range can be dimensioned such that the spatial area to be monitored can also extend more or less over the wings 8. FIG. 1 indicates, by way of example, an angular range αy of approximately 300°.

As mentioned above, it is conceivable to place one further sensor device or a plurality of further sensor devices on the aircraft 2, which device(s) additionally scan(s) a top side. In this respect, it could be appropriate to fit a further sensor device 15 to the vertical tail unit 13, as respectively indicated in FIGS. 1 to 3.

The sensor devices 14, 15, 16 and 18 are connected to a control unit 28 which is arranged, merely by way of example, in a front area of the aircraft fuselage 6. In addition to implementing an independent control unit 28, the functions of the latter may also be implemented in a control or computing unit which is already present.

The control unit 28 is designed to receive capture data from the sensor devices 14, 15, 16 and 18 via a first interface 38. During normal monitoring, the sensor devices 14, 15, 16 and 18 can continuously transmit capture data to the control unit 28. The capture data may be both raw data and already processed data which may contain information relating to the position, size and speed of a captured object. The control unit 28 is designed to use the received capture data from all sensor devices 14, 15, 16 and 18 to detect whether an object is situated in or enters a predefined monitoring area.

It is also advantageous if the control unit 28 at least roughly knows the geometry of the aircraft 2 as well as the installation positions of the sensor devices 14, 15, 16 and 18 used. The control unit 28 can define a monitoring area 30 around the contour of the aircraft 2, which monitoring area extends outwards by a certain distance from the outer side of the aircraft 2, for example horizontally. It goes without saying that a monitoring area 30 as such may also be defined without knowledge of the geometry of the aircraft 2 and can then be monitored.

The sensor devices 14, 15, 16 and 18 are placed in such a manner that they jointly cover the monitoring area 30, in particular in an overlapping manner, with the result that an object in the monitoring area 30 is always captured by at least one of the sensor devices 14, 15, 16 and 18. The control unit 28 can calculate an absolute position of the detected objects from the capture data from the sensor devices 14, 15, 16 and 18 and from the known installation positions of the latter. This can be carried out, for instance, by transforming coordinates of a detected object from a local coordinate system, which is assigned to a sensor device, into an aircraft-fixed coordinate system, after which the position of the object in the vehicle-fixed coordinate system is compared with the spatial extent of the monitoring area 30. If an object is in the monitoring area 30 according to this comparison, this object is considered to have been detected in the monitoring area 30.

If an object is detected in the monitoring area 30, the control unit 28 transmits a control signal 32 to a signal output device 34 via a second interface 40. This signal output device need not necessarily be only an individual signal output device 34, but rather it is appropriate to use a plurality of signal output devices 34 with different functions.

The signal output device 34 can be designed to output an optical and/or acoustic warning. A further signal output device 34 can be in the form of a camera device 42 which is designed to generate and provide camera images. The camera images can be provided on a storage medium and alternatively or additionally can also be directly transmitted to the aircraft 2 or to the outside via a data connection device 44. The storage medium for storing the camera images can be in the form of a memory unit 36 of the control unit 28. Alternatively or additionally, the storage medium may also be implemented by a memory unit (not illustrated) assigned to the camera device 42.

The data connection device 44 can be understood as a further signal output device since, after receiving a control signal 32, it initiates a data connection to an external device and forwards information, which is understood as meaning a warning signal or contains the latter, or, in addition to a warning signal transmitted from the data connection device 44 or another component, communicates camera images and parameters to the outside.

In order to record events, it is advisable to store a plurality of parameters in the memory unit 36 of the control unit 28. These parameters can comprise the detection time, the size of the detected object, the speed of the detected object and/or the position or the position profile of the detected object. The proper function of the system 4 can therefore also be checked if necessary.

The monitoring process may furthermore also comprise the creation of a plurality of monitoring areas. The monitoring area 30 shown in the figures could be subdivided into two capture areas 30a and 30b, for instance. The first capture area 30a is an inner monitoring area which directly adjoins the outer side of the aircraft 2. The second capture area 30b is arranged on the outside and is at a greater distance from the outer side of the aircraft 2. If both capture areas are used, the capture of an object can consequently be associated with two warning levels. If an object enters the outer, second capture area 30b, the warning should be output with a lower warning level than if an object moves into the first, inner capture area 30a. It goes without saying that a plurality of such capture areas are also conceivable, for instance a third capture area, a fourth capture area etc.

It is additionally pointed out that “having” does not exclude any other elements or steps and “one” or “a(n)” does not exclude a multiplicity. It is also pointed out that features which have been described with reference to one of the exemplary embodiments above can also be used in combination with other features of other exemplary embodiments described above. Reference signs in the claims should not be considered to be a restriction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for monitoring access to a vehicle, comprising:
a control unit, a plurality of sensor devices configured to be fastened to an outer side of the vehicle, are coupled to the control unit and are configured to capture objects in a three-dimensional manner in the field of view of the sensor devices, and
at least one signal output device which is coupled to the control unit,
wherein the sensor devices are configured to capture objects in spatial areas predetermined by the relevant sensor devices and to transmit capture data representing the capture of objects to the control unit,
wherein the control unit is configured to receive the capture data and to use the capture data to detect an object approaching a predefined monitoring area covered by the predetermined spatial areas of the sensor devices,
wherein the control unit is designed to transmit a control signal to the at least one signal output device if an object is detected, and
wherein the signal output device is configured to output a warning signal if the control signal is received.

2. The system according to claim 1, wherein the sensor devices are LIDAR sensors.

3. The system according to claim 1,
wherein the control unit is configured to subdivide the monitoring area into a first capture area and a second capture area,
wherein the first capture area is surrounded by the second capture area, and
wherein the control unit is configured to transmit a first control signal to the at least one signal output device if an object is detected in the first capture area and to transmit a second control signal to the at least one signal output device if an object is detected in the second capture area.

4. The system according to claim 1, further comprising a camera device as one of the at least one signal output device,
wherein the control unit is coupled to the camera device, and
wherein the system is configured to at least one of initiate or provide an image recording from the camera device when sending the control signal to the camera device.

5. The system according to claim 1, wherein the control unit is configured to determine the size of an end face of a detected object that is directed to one of the sensor devices and to transmit a control signal to the signal output device only above a predefined minimum size.

6. The system according to claim 1, wherein the control unit is designed to record at least one parameter if an object is detected for a predefined period, which parameter is selected from a group of parameters having:
a detection time;
a size of the detected object;
a speed of the detected object;
a position or position profile of the detected object.

7. The system according to claim 1, further comprising a data connection device as one of the at least one signal output device,
wherein the data connection device is configured to set up a data connection to a device outside the vehicle and to transmit a warning signal to the device outside the vehicle.

8. An aircraft having a system according to claim 1.

9. The aircraft according to claim 8, wherein the predetermined spatial areas of all sensor devices together contain at least all access openings of the aircraft.

10. The aircraft according to claim 8, wherein one of the sensor devices is arranged on an underside of a tail cone.

11. The aircraft according to claim 8, wherein two of the sensor devices are arranged in an area of a front edge of wings close to a wing root.

12. The aircraft according to claim 8, wherein a sensor device is arranged on a vertical tail unit.

13. The aircraft according to claim 8, further comprising a camera system as a signal output device.

14. The aircraft according to claim 8, further comprising a wireless data connection device as a signal output device.

15. A method of monitoring an area surrounding an aircraft comprising:
deploying one or more LIDAR sensors on an aircraft arranged and configured to capture objects in a three-dimensional manner in a field of view of the LIDAR sensors,
monitoring an output from the LIDAR sensors.
